(19) United States
(12) Patent Application Publication
(10) Pub. No.: US 2025/0125376 A1
(43) Pub. Date: Apr. 17, 2025

(54) COMPOSITE METAL FOIL AND LITHIUM BATTERY INCLUDING THE SAME

(71) Applicant: Industrial Technology Research Institute, Hsinchu (TW)

(72) Inventors: Chiu-Yen Chiu, Hsinchu County (TW); Li-Ju Chen, Hsinchu City (TW); Sheng-Hui Wu, Hsinchu City (TW)

(73) Assignee: Industrial Technology Research Institute, Hsinchu (TW)

(21) Appl. No.: 18/817,254

(22) Filed: Aug. 28, 2024

Related U.S. Application Data
(60) Provisional application No. 63/589,637, filed on Oct. 12, 2023.

(30) Foreign Application Priority Data
May 22, 2024 (TW) 113118886

(51) Int. Cl. H01M 4/66; H01M 4/62; H01M 10/052

(52) U.S. Cl. CPC H01M 4/667; H01M 4/628; H01M 4/662; H01M 4/668; H01M 10/052

(57) ABSTRACT

A composite metal foil and a lithium battery including the same are provided, wherein the composite metal foil includes a conductive substrate, a first metal layer, and a second metal layer. The first metal layer is disposed at at least one surface of the conductive substrate and in direct contact with the conductive substrate, and the first metal layer is nickel (Ni). The second metal layer is disposed at a surface of the first metal layer. A nucleation overpotential of the second metal layer is less than a nucleation overpotential of the first metal layer, and a material of the second metal layer is at least one selected from the group consisting of zinc (Zn), tin (Sn), indium (In), silver (Ag), a zinc alloy, and a tin alloy.

### CROSS-REFERENCE TO RELATED APPLICATION

This application claims the priority benefit of U.S. Provisional Application No. 63/589,637, filed on Oct. 12, 2023 and Taiwan Application No. 113118886, filed on May 22, 2024. The entirety of each of the above-mentioned patent applications is hereby incorporated by reference herein and made a part of this specification.

### TECHNICAL FIELD

The disclosure relates to a composite metal foil and a lithium battery including the same.

### BACKGROUND

In a lithium battery system using sulfur-based solid-state electrolyte, due to the generation of hydrogen sulfide (H₂S), the existing copper foil is insufficient to resist H₂S corrosion, thus affecting battery life. Therefore, there are currently studies on using stainless steel to replace copper foil. Also, in the case of a sulfide solid-state battery with no negative electrode, low lithium, or lithium metal negative electrode, the function of the current collector in the structure thereof is no longer just a simple current collection function. If the surface of the current collector is not lithium-friendly, lithium is readily deposited irregularly, resulting in the formation of lithium dendrites causing short circuits. Therefore, there is a need to develop a new current collector material to overcome the above issues.

### SUMMARY

A composite metal foil of the disclosure includes a conductive substrate, a first metal layer, and a second metal layer. The first metal layer is disposed at at least one surface of the conductive substrate and in direct contact with the conductive substrate, and the first metal layer is nickel (Ni). The second metal layer is disposed at a surface of the first metal layer. A nucleation overpotential of the second metal layer is less than a nucleation overpotential of the first metal layer, and a material of the second metal layer is at least one selected from the group consisting of zinc (Zn), tin (Sn), indium (In), silver (Ag), a zinc alloy, and a tin alloy.

A lithium battery of the disclosure includes a sulfur-based solid-state electrolyte, and an electrode of the lithium battery includes the above composite metal foil.

Several exemplary embodiments accompanied with figures are described in detail below to further describe the disclosure in details.

### BRIEF DESCRIPTION OF THE DRAWINGS

FIG. 1A is a schematic cross-sectional view of a composite metal foil according to an embodiment of the disclosure.

FIG. 1B is a schematic cross-sectional view of a composite metal foil according to another embodiment of the disclosure.

FIG. 2 is a schematic cross-sectional view of a composite metal foil according to another embodiment of the disclosure.

FIG. 3 is a CV curve of a lithium battery including the composite metal foil of Example 1.

FIG. 4 is a CV curve of a lithium battery including the composite metal foil of Comparative example 5.

FIG. 5 is a CV curve of a lithium battery including the composite metal foil of Example 6.

FIG. 6 is a CV curve of a lithium battery including the composite metal foil of Example 8.

FIG. 7 is a CV curve of a lithium battery including the composite metal foil of Comparative example 11.

### DETAILED DESCRIPTION OF DISCLOSED EMBODIMENTS

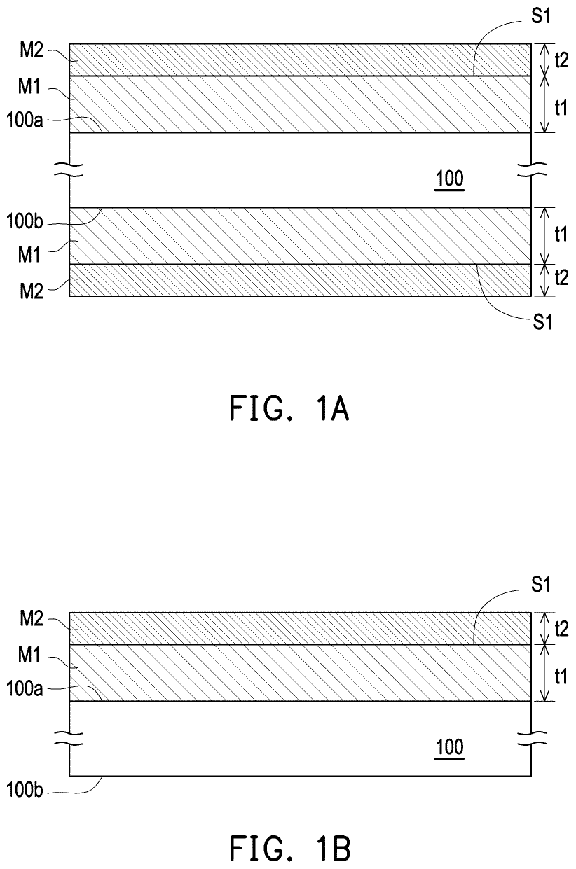

FIG. 1A is a schematic cross-sectional view of a composite metal foil according to an embodiment of the disclosure.

Referring to FIG. 1A, the composite metal foil includes a conductive substrate 100, a first metal layer M1, and a second metal layer M2. The first metal layer M1 is disposed at two surfaces 100a and 100b of the conductive substrate 100 and in direct contact with the conductive substrate 100. However, the disclosure is not limited thereto. In another embodiment, the first metal layer M1 may be disposed only on one surface 100a of the conductive substrate 100, as shown in FIG. 1B. The first metal layer M1 is nickel (Ni), and a thickness t1 of the first metal layer M1 is, for example, 0.05 μm to 2 μm, or 0.15 μm to 2 μm, or 0.2 μm to 2 μm. The conductive substrate 100 is copper foil or polymer composite copper foil. If the conductive substrate 100 is copper foil, the thickness is about 3 μm to 30 μm, but is not limited thereto. The polymer composite copper foil may be a sandwich structure composite foil, such as including a polymer film and a copper metal layer disposed at two sides thereof, wherein the thickness of the copper metal layer is about 0.5 μm to 5 μm, and the polymer film may be a high-temperature resistant polymer, such as polyethylene terephthalate (PET), polyimide (PI), polyester (PE), polypropylene (PP), polyacrylonitrile (PAN), poly(methyl methacrylate) (PMMA), polydimethylsiloxane (PDMS), or a combination of the above, and the thickness thereof may be about 1 μm to 10 μm.

The second metal layer M2 is disposed at the surface S1 of the first metal layer M1, and the surface S1 here refers to the outer surface of the first metal layer M1. The nucleation overpotential of the second metal layer M2 is less than the nucleation overpotential of the first metal layer M1. The material of the first metal layer M1 may be nickel, and the material of the second metal layer M2 may be at least one selected from the group consisting of zinc (Zn), tin (Sn), indium (In), silver (Ag), a zinc alloy, and a tin alloy. “Nucleation overpotential” refers to the difference between the lowest point of polarizing overpotential produced by lithium deposition at the copper foil and the equilibrium potential. In an embodiment, the zinc alloy includes a zinc-nickel alloy, and the zinc content in the zinc-nickel alloy may be 80 wt % or more, such as 90 wt % or more or 95 wt % or more. In an embodiment, the tin alloy includes a tin-nickel alloy, and the tin content in the tin-nickel alloy is 80 wt % or more, such as 90 wt % or more or 95 wt % or more. In the present embodiment, a thickness t2 of the second metal layer M2 is 0.01 μm to 0.2 μm, or 0.03 μm to 0.2 μm.

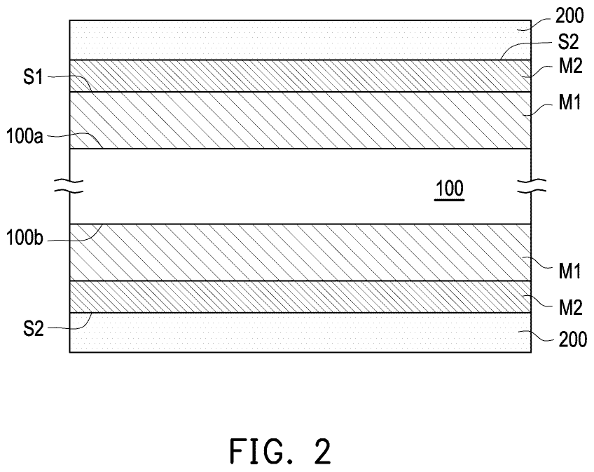

FIG. 2 is a schematic cross-sectional view of a composite metal foil of another embodiment of the disclosure, wherein the same reference numerals as in the previous embodiment are used to represent the same or similar layers or parts, and the same layers or parts are not described again.

In FIG. 2, the composite metal foil may further include an anti-oxidation layer 200 that may cover a surface S2 of the second metal layer M2, and the surface S2 here refers to the outer surface of the second metal layer M2. In an embodiment, the anti-oxidation layer 200 may be formed of chromic acid, benzotriazole (BTA), carboxybenzotriazole (CBTA), or methylbenzotriazole (MBTA).

The composite metal foil of FIG. 2 may be produced by, for example, but not limited to, first electroplating the first metal layer M1 at the surfaces 100a and 100b of the conductive substrate 100, then, the second metal layer M2 is electroplated on the surface S1 of the first metal layer M1, and then the anti-oxidation layer 200 is formed on the surface S2 of the second metal layer M2 using a dipping method or a coating method. In addition, after the anti-oxidation layer 200 is formed, heat treatment may be performed in an environment of 100° C. to 250° C. for 1 minute to 60 minutes to enhance the structural compactness of the composite metal foil.

Several experiments are listed below to verify the efficacy of the disclosure, but these experiments and the results thereof are not used to limit the scope of application of the disclosure.

### Preparation Example

Step 1. A copper plating solution (Cu²⁺: 60 g/L (CuSO₄), H₂SO₄: 90 g/L, Cl⁻: 30 ppm (HCl), Chemleader corporation DP-111L additive) was prepared and heated to 40° C., the rotation speed of a rotating column electrode was controlled at 800 rpm, and electroplating was performed at a current density of 50 A/dm² for 48 seconds to obtain 8 μm base copper (i.e., conductive substrate, HTCu).

Step 2. Electroplating of the first metal layer was performed to form a first metal layer at a surface of a copper foil. The method was to put the rotating column electrode including the base copper into the plating solution, and at a temperature of 50° C., the current density was 5 A/dm² and the plating time was controlled (such as several seconds to tens of seconds) to obtain a first metal layer of a predetermined thickness. The composition of the plating solution is shown in Table 1 below, and the material and the thickness of the first metal layer are recorded in Table 2 below.

Step 3. Second metal layer electroplating was performed to form a second metal layer on the first metal layer of the copper foil. The method was to put the rotating column electrode including the base copper and the first metal layer into the plating solution, and the plating time (such as several seconds) was controlled at a current density of 1 A/dm² to obtain a second metal layer of a predetermined thickness. The composition of the plating solution is shown in Table 1 below, and the material and the thickness of the second metal layer are recorded in Table 2 below.

TABLE 1

| Plating | |
|---|---|
| material | Plating solution composition |
| Zinc | Zn²⁺: 5 g/L (ZnSO₄), CH₃COONa 10 g/L, pH 3.5 to 4.5 |
| Tin | SnCl₂•2H₂O 22.6 g/L, K₄P₂O₇ 119 g/L, gelatin 1 g/L, |
| | pH 8.6 |
| Nickel | NiSO₄•6H₂O 300 g/L, NiCl₂ 40 g/L, H₃BO₃ 40 g/L, 50° C. |
| Zinc nickel | Zn²⁺ 1 g/L(ZnSO₄), Ni²⁺ 4 g/L(NiSO₄), CH₃COONa |
| | 10 g/L, pH 3.5 to 4.5 |
| Tin nickel | SnCl₂ 0.1M, NiCl₂ 0.2M, K₄P₂O₇ 165 g/L, gelatin 1 g/L |

Step 4. After the electroplated product in step 3 was rinsed, the electroplated product was immersed in an anti-oxidation layer (chromic acid) solution to form an anti-oxidation layer.

Optional step 5. The product of step 4 was placed into an atmosphere furnace for heat treatment. The temperature is as shown in Table 2 and the time was 30 minutes or less.

TABLE 2
(Except for Comparative example 2, the conductive
substrates were all 8 μm base copper (HTCu))

| | First metal | Second metal | |
|---|---|---|---|
| | layer and | layer and | Heat treatment |
| | thickness | thickness | temperature |
| Experiment | thereof | thereof | (° C.) |
| Comparative | — | — | — |
| example 1 | | | |
| Comparative | German Thyssenkrupp 10 μm stainless steel foil (brand: | | |
| example 2 | X5CrNi189) was used | | |
| Comparative | 100 nm Ni | — | — |
| example 3 | | | |
| Comparative | 200 nm Ni | — | — |
| example 4 | | | |
| Example 1 | 200 nm Ni | 30 nm Zn | — |
| Example 2 | 200 nm Ni | 15 nm Zn | — |
| Example 3 | 200 nm Ni | 45 nm Zn | — |
| Example 4 | 200 nm Ni | 30 nm Zn | 200 |
| Comparative | — | (Co-plated) 180 nm ZnNi | — |
| example 5 | | | |
| Comparative | — | (Co-plated) 180 nm ZnNi | 200 |
| example 6 | | | |
| Comparative | — | 200 nm Sn | — |
| example 7 | | | |
| Comparative | — | 150 nm Sn | 140 |
| example 8 | | | |
| Comparative | — | 200 nm Sn | 140 |
| example 9 | | | |
| Example 5 | 150 nm Ni | (Co-plated) 15 nm SnNi | — |
| Example 6 | 150 nm Ni | (Co-plated) 30 nm SnNi | — |
| Comparative | — | (Co-plated) 200 nm SnNi | |
| example 10 | | | |
| Example 7 | 150 nm Ni | (Co-plated) 15 nm SnNi | 140 |
| Example 8 | 150 nm Ni | (Co-plated) 30 nm SnNi | 140 |
| Comparative | — | (Co-plated) 150 nm SnNi | 140 |
| example 11 | | | |
| Comparative | — | (Co-plated) 200 nm SnNi | 140 |
| example 12 | | | |
| Example 9 | 200 nm Ni | (Co-plated) 30 nm SnNi | — |
| Example 10 | 200 nm Ni | (Co-plated) 45 nm SnNi | — |
| Example 11 | 200 nm Ni | (Co-plated) 30 nm SnNi | 140 |
| Example 12 | 200 nm Ni | (Co-plated) 45 nm SnNi | 140 |
| Comparative | 30 nm Zn | 150 nm Ni | — |
| example 13 | | | |

### <Component Analysis>

Component analysis was performed on the composite metal foils of Example 1, Example 12, Comparative example 5, and Comparative example 12. The metal foils were completely dissolved in concentrated hydrochloric acid and then diluted for ICP component testing. The analysis results are shown in Table 3.

TABLE 3

| Experiment | Plating conditions | ICP plating analysis |
|---|---|---|
| Example 1 | 8 μm HTCu/200 nm Ni/ 30 | Ni: 13.5 mg/dm² |
| | nm Zn | Zn: 2.78 mg/dm² |
| Comparative | 8 μm HTCu/ 180 nm ZnNi | Ni: 0.25 mg/dm² |
| example 5 | | Zn: 7.24 mg/dm² |
| Example 12 | 8 μm HTCu/200 nm Ni/ 30 | Ni: 18.75 mg/dm² |
| | nm SnNi | Sn: 0.883 mg/dm² |
| Comparative | 8 μm HTCu/200 nm SnNi | Ni: 0.141 mg/dm² |
| example 12 | | Sn: 5.43 mg/dm² |

Since the samples were dissolved, in the result with Ni/SnNi (such as Example 12), Ni was much higher. If simply observing the sample with only the tin-nickel alloy layer (Comparative example 12), the weight ratio of Sn and Ni was approximately 0.975:0.025. In the same way, simply observing the sample with only zinc-nickel alloy layer (Comparative example 5), the weight ratio of Zn and Ni was approximately 0.967:0.033.

### <Battery Characteristic Analysis>

The solid-state electrolyte was sulfide solid electrolyte argyrodite type (Li₆PS₅Cl). The composite metal foils of Examples 1 to 12 and Comparative examples 1 to 13 in Table 2 were used as the working electrode, and the lithium metal foil was used as the counter electrode, to assemble a CR2032-type button battery (all-solid-state half-cell).

Cyclic voltammetry (CV) test was performed at room temperature 25° C. at a scan rate of 5 mV/s, scanning from the open circuit potential to low potential to 0.01 V (vs. Li/Li⁺), and then to high potential to 5 V (vs. Li/Li⁺), and 100 cycles were performed.

During the cyclic voltammetry test, the current density generated by scanning from high potential to low potential is called reduction current density; the current density generated by scanning from low potential to high potential is called oxidation current density. The lower the absolute value of the oxidation current density or the reduction current density, the lower the reactivity between the working electrode and the sulfide solid-state electrolyte, so as to determine the sulfide resistance of the composite metal foil. The test results are shown in Table 4 to Table 5.

TABLE 4

| | Maximum oxidation current | | | | | Maximum reduction current | | | | |
|---|---|---|---|---|---|---|---|---|---|---|
| | density (μA/cm²) | | | | | density (μA/cm²) | | | | |
| | Number of cycles | | | | | Number of cycles | | | | |
| | 1 | 10 | 20 | 50 | 100 | 1 | 10 | 20 | 50 | 100 |
| Comparative | 8.8 | 190.0 | >1000 | — | — | 9.4 | 222.0 | 322.0 | — | — |
| example 1 | | | | | | | | | | |
| Comparative | 0.5 | 0.8 | 0.9 | 1.3 | 2.3 | 2.7 | 3.1 | 3.4 | 4.2 | 5.2 |
| example 2 | | | | | | | | | | |
| Comparative | 1.5 | 124.3 | 68.9 | >1000 | >1000 | 2.4 | 238.0 | 185.8 | 25.7 | 27.8 |
| example 3 | | | | | | | | | | |
| Comparative | 0.9 | 29.3 | 36.3 | 16.3 | 13.9 | 3.2 | 60.7 | 88.3 | 19.4 | 10.8 |
| example 4 | | | | | | | | | | |
| Example 1 | 0.6 | 6.9 | 5.7 | 5.3 | 2.1 | 3.0 | 10.9 | 6.3 | 4.5 | 2.3 |
| Example 2 | 1.0 | 6.0 | 6.7 | 4.0 | 3.8 | 3.4 | 12.0 | 12.7 | 9.1 | 6.9 |
| Example 3 | 0.9 | 9.9 | 21.5 | 7.5 | 5.4 | 4.5 | 11.1 | 30.0 | 17.0 | 13.5 |
| Comparative | 7.1 | 8.9 | 33.3 | 233.7 | 230.3 | 36.5 | 39.9 | 35.9 | 29.5 | 29.9 |
| example 5 | | | | | | | | | | |
| Comparative | 3.6 | 9.8 | 165.9 | 397.0 | >1000 | 23.4 | 44.8 | 41.7 | 33.1 | 27.8 |
| example 6 | | | | | | | | | | |
| Comparative | 4.8 | 49.7 | 69.0 | 46.1 | 629.8 | 60.3 | 58.9 | 102.1 | 105.5 | 175.0 |
| example 7 | | | | | | | | | | |
| Comparative | 4.2 | 172.7 | 212.3 | 83.9 | >1000 | 69.1 | 209.7 | 327.6 | 150.8 | 115.4 |
| example 8 | | | | | | | | | | |
| Comparative | 6.4 | >1000 | >1000 | >1000 | >1000 | 77.4 | 487.8 | 630.8 | 220.6 | 318.3 |
| example 9 | | | | | | | | | | |

It may be seen from Table 4 that Comparative example 1 was a simple copper foil, and the CV result thereof was that the absolute value of the reduction current density was greater than 30 μA cm⁻² after the 10th cycle, indicating the simple copper foil had high reactivity with the sulfide solid-state electrolyte; Comparative example 2 was commercially available stainless steel, and although the absolute value of the reduction current density was small, the cost was high. In Comparative examples 3 and 4, a nickel layer was added to the copper foil, but the absolute value of the reduction current density was greater than 30 μA cm⁻² in the 10th to 20th cycles. As for Examples 1 to 3, in addition to plating the nickel layer on the copper foil, a zinc layer was added. The CV results thereof show that the absolute values of the redox current densities after 100 cycles were all less than 30 μA cm⁻². However, when co-plated zinc-nickel was used on the copper foil instead (Comparative examples 5 to 6), the CV results thereof show that the absolute values of the redox current densities were already greater than 30 μA cm⁻² after 20 cycles. In the same way, tin plating was performed directly on the copper foil (Comparative examples 7 to 9), and the CV results thereof show that the absolute values of the redox current densities were already greater than 30 μA cm⁻² after 10 cycles regardless of whether heat treatment was performed.

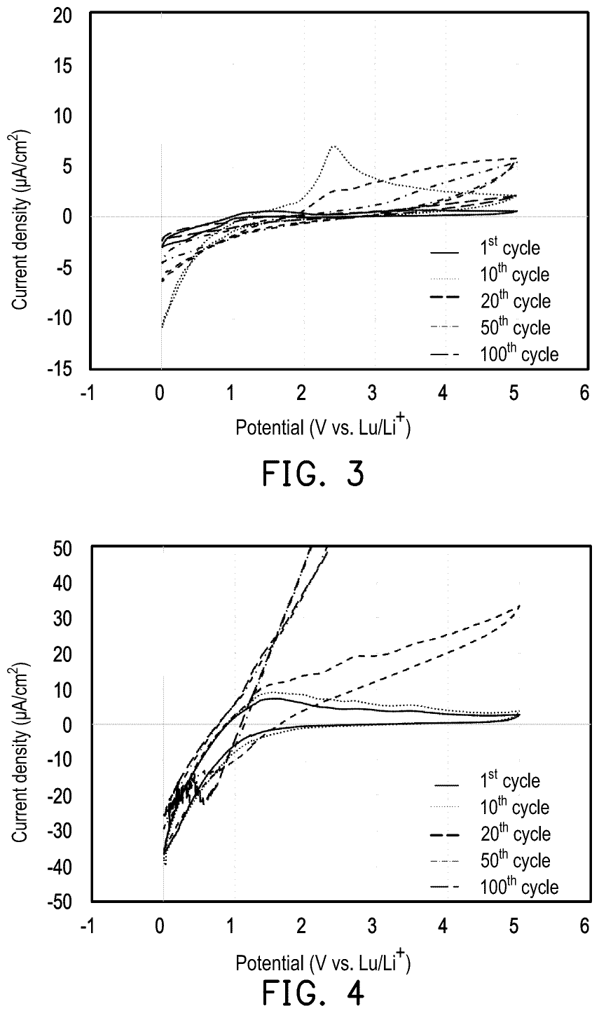

Also, please refer to FIG. 3 and FIG. 4, wherein FIG. 3 is a CV curve of a lithium battery including the composite metal foil of Example 1 and FIG. 4 is a CV curve of a lithium battery including the composite metal foil of Comparative example 5. In the curve of FIG. 3, at both the 1st cycle and the 100th cycle, the change in current density is significantly less than that in FIG. 4, indicating the composite metal foil of the disclosure has low reactivity with sulfide solid-state electrolyte.

TABLE 5

| | Maximum oxidation current | | | | | Maximum reduction current | | | | |
|---|---|---|---|---|---|---|---|---|---|---|
| | density (μA/cm²) | | | | | density (μA/cm²) | | | | |
| | Number of cycles | | | | | Number of cycles | | | | |
| | 1 | 10 | 20 | 50 | 100 | 1 | 10 | 20 | 50 | 100 |
| Example 5 | 0.7 | 3.2 | 5.2 | 4.7 | 2.5 | 9.0 | 12.0 | 15.1 | 11.4 | 8.1 |
| Example 6 | 3.5 | 8.6 | 15.7 | 16.4 | 9.9 | 12.6 | 21.8 | 30.1 | 34.0 | 24.0 |
| Comparative | 8.4 | >1000 | >1000 | >1000 | — | 18.1 | 172.8 | 313.0 | 208.4 | — |
| example 10 | | | | | | | | | | |
| Example 7 | 1.1 | 24.5 | 28.7 | 14.6 | 8.2 | 14.6 | 32.5 | 55.2 | 37.4 | 21.5 |
| Example 8 | 1.5 | 11.8 | 16.2 | 7.3 | 4.4 | 28.8 | 35.3 | 44.2 | 25.1 | 16.3 |
| Comparative | 2.0 | 165.1 | 239.4 | 240.3 | >1000 | 72.1 | 225.4 | 325.0 | 109.4 | 115.7 |
| example 11 | | | | | | | | | | |
| Comparative | 9.5 | 57.0 | 78.2 | 41.7 | 43.0 | 107.1 | 71.6 | 118.4 | 81.5 | 84.9 |
| example 12 | | | | | | | | | | |
| Example 9 | 1.9 | 12.6 | 18.9 | 16.6 | 13.8 | 29.2 | 40.5 | 46.4 | 40.9 | 35.1 |
| Example 10 | 1.7 | 6.8 | 6.2 | 6.4 | 5.0 | 36.9 | 30.0 | 33.7 | 24.0 | 17.0 |
| Example 11 | 2.6 | 5.7 | 7.0 | 6.3 | 3.3 | 15.7 | 18.2 | 19.0 | 16.4 | 10.3 |
| Example 12 | 0.4 | 3.5 | 5.2 | 8.1 | 3.2 | 13.9 | 14.4 | 15.9 | 18.1 | 8.1 |
| Comparative | 3.50 | 255.16 | — | — | — | 12.31 | 30.02 | — | — | — |
| example 13 | | | | | | | | | | |

It may be seen from Table 5 that in Examples 5 to 8, the copper foil was plated with a nickel layer and a tin-nickel layer. The CV results thereof show that the absolute values of the oxidation current densities were all less than 30 μA cm⁻² regardless of whether heat treatment was performed, and the absolute values of the reduction current densities after 100 cycles were all less than 30 μA cm⁻². The CV results of Comparative examples 10 to 12 in which the tin-nickel layer was directly plated on the copper foil show that the absolute values of the reduction current densities were already greater than 30 μA cm⁻² after 10 cycles, regardless of whether heat treatment was performed. In Examples 9 to 12, copper foil was plated with a 200 nm nickel layer and tin-nickel layers of different thicknesses. The CV results thereof show that the absolute values of the redox current densities after heat treatment were less, and all were less than 30 μA cm⁻². In Comparative example 13, in which the copper foil was first plated with zinc and then plated with nickel layer, the CV result thereof shows that the absolute value of the reduction current density after the 10th cycle was greater than 30 μA cm⁻².

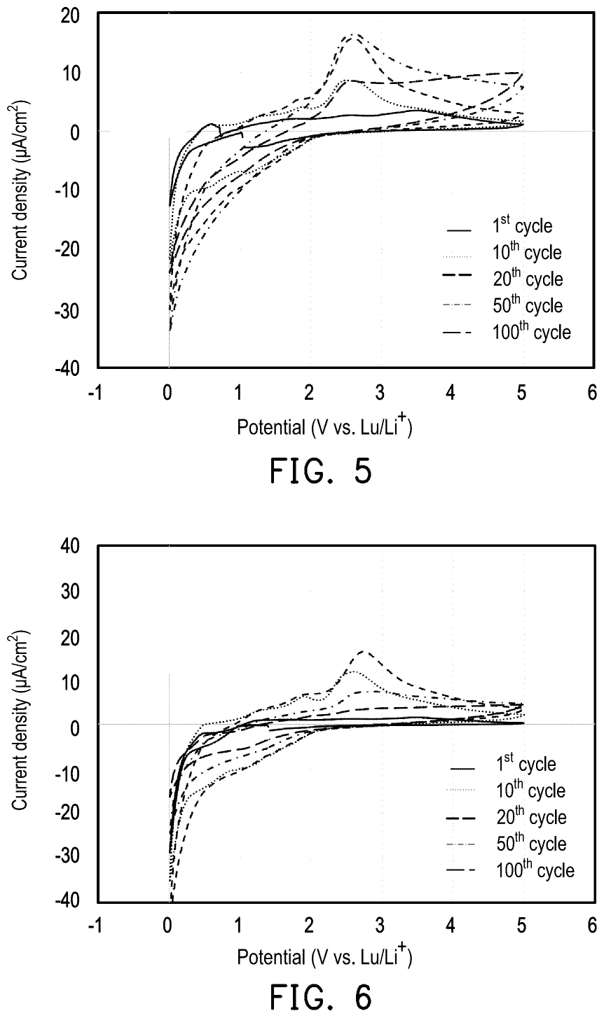

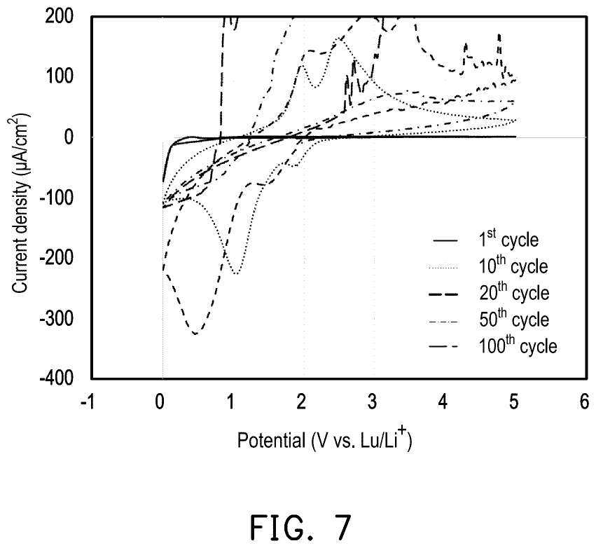

Also, please refer to FIG. 5 to FIG. 7, wherein FIG. 5 is a CV curve of a lithium battery including the composite metal foil of Example 6, FIG. 6 is a CV curve of a lithium battery including the composite metal foil of Example 8, and FIG. 7 is a CV curve of a lithium battery including the composite metal foil of Comparative example 11. The changes in current density of FIG. 5 and FIG. 6 are significantly less than those in FIG. 7, indicating that the composite metal foil including a double metal layer of the disclosure, regardless of whether a heat treatment was performed thereto, had less reactivity with the sulfide solid-state electrolyte than a composite metal foil with only a single tin-nickel layer.

### <High Temperature Battery Characteristics>

CR2032-type coin batteries including the composite metal foils of Comparative example 1, Comparative example 2, and Example 1 were produced as described in <Battery characteristic analysis>. Cyclic voltammetry test was performed at 55° C. at a scan rate of 5 mV/s, scanning from the open circuit potential to low potential to 0.01 V (vs. Li/Li⁺), and then to high potential to 5 V (vs. Li/Li⁺), and 10 cycles were performed. The test results are shown in Table 6.

TABLE 6

| | Maximum oxidation current | | Maximum reduction current | |
|---|---|---|---|---|
| | density (μA/cm²) | | density (μA/cm²) | |
| | Cycle 1 | Cycle 10 | Cycle 1 | Cycle 10 |
| | time | times | time | times |
| Comparative | 9.91 | 191 | 40 | 106 |
| example 1 | | | | |
| Comparative | 59.98 | >1000 | 147.0 | 136.98 |
| example 2 | | | | |
| Example 1 | 6.12 | 22.90 | 15.08 | 24.39 |

It may be seen from Table 6 that the composite metal foil of the disclosure (Example 1) had better stability at high temperatures than the stainless-steel foil (Comparative example 2).

### <Nucleation Overpotential>

Test method: CR2032-type coin batteries including the composite metal foils in Table 7 below were made according to the method as described in <Battery characteristic analysis>, the charge and discharge current density was set to 0.01 mA/cm² to 0.05 mA/cm², and the batteries were charged for 0.8 hours.

The nucleation overpotential (ΔVₙᵤ) is defined as the difference between the lowest point of the polarizing overpotential generated by lithium deposition at the copper foil and the equilibrium potential. The equation is as shown in formula (1):

$$Δ {V}_{nu} = {V}_{nu} - {V}_{balance} \qquad ( 1 )$$

In formula (1), Vₙᵤ is the lowest point potential (V) formed after lithium metal is deposited; V_{balance} is the equilibrium stable potential (V).

The ΔVₙᵤ obtained after measuring the potentials and calculating is recorded in Table 7 below.

TABLE 7

| | ΔVₙᵤ (mV) |
|---|---|
| Comparative example 1 (8 μm base copper) | 47.3 |
| Comparative example 2 (stainless steel foil) | 47.3 |
| Comparative example 4 (copper foil/200 nm Ni) | 44 |
| Comparative example 5 (copper foil/180 nm ZnNi) | 43.8 |
| Example 1 (copper foil/200 nm Ni/30 nm Zn) | 13.5 |
| Example 10 (copper foil/200 nm Ni/45 nm SnNi) | 20.5 |
| Example 11 (copper foil/200 nm Ni/30 nm SnNi, heat | 6 |
| treatment) | |
| Example 12 (copper foil/200 nm Ni/45 nm SnNi, heat | 7.9 |
| treatment) | |

It may be seen from Table 7 that the nucleation overpotentials of the composite metal foils of the disclosure were all less than that in which only a nickel layer was formed on the copper foil, that is, less than 44 mV, such as less than 30 mV or less than 20 mV.

Based on the above experimental results, the following Table 8 is obtained via a simple evaluation according to the following numerical ranges.

### Reactivity at Room Temperature:

X: maximum reduction current density of 100th cycle (absolute value)>30 μA/cm².
O: maximum reduction current density of 100th cycle (absolute value)<30 μA/cm².

### Reactivity at High Temperature:

X: maximum reduction current density of 10th cycle (absolute value)>30 μA/cm².
O: maximum reduction current density of 10th cycle (absolute value)<30 μA/cm².

### Nucleation Overpotential:

X: >30 mV.
O: <30 mV.

TABLE 8

| | | Reactivity | Reactivity | Nucle- |
|---|---|---|---|---|
| | | at room | at high | ation |
| Plating of copper | Thickness | temper- | temper- | overpo- |
| foil surface | (nm) | ature | ature | tential |
| None | — | X | X | X |
| Only Ni plating | 100 to 200 | X | — | X |
| Only ZnNi plating | 180 | X | X | X |
| Zn plating first then | Zn: 30 | X | — | — |
| Ni plating | Ni: 50 to 150 | | | |
| Ni plating first then | Ni: 200 | ◯ | ◯ | ◯ |
| Zn plating | Zn: 15 to 45 | | | |
| Only Sn plating | 150 to 200 | X | — | — |
| Only SnNi plating | 100 to 200 | X | — | — |
| Ni plating first then | Ni: 150 to 200 | ◯ | ◯ | ◯ |
| SnNi plating | SnNi: 15 to 45 | | | |

It may be seen from Table 8 that the composite metal foil of the disclosure has low reactivity towards sulfide solid-state electrolyte and has less nucleation overpotential and is therefore suitable for a lithium battery including sulfur-based solid-state electrolyte, thereby improving battery performance and battery life.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A composite metal foil, comprising:
a conductive substrate;
a first metal layer disposed at at least one surface of the conductive substrate and in direct contact with the conductive substrate; and
a second metal layer disposed at a surface of the first metal layer, wherein
the first metal layer is nickel (Ni),
a nucleation overpotential of the second metal layer is less than a nucleation overpotential of the first metal layer, and a material of the second metal layer is at least one selected from the group consisting of zinc (Zn), tin (Sn), indium (In), silver (Ag), a zinc alloy, and a tin alloy.

2. The composite metal foil of claim 1, wherein the zinc alloy comprises a zinc-nickel alloy, and a zinc content in the zinc-nickel alloy is 80 wt % or more.

3. The composite metal foil of claim 1, wherein the tin alloy comprises a tin-nickel alloy, and a tin content in the tin-nickel alloy is 80 wt % or more.

4. The composite metal foil of claim 1, wherein a thickness of the first metal layer is 0.05 μm to 2 μm.

5. The composite metal foil of claim 1, wherein a thickness of the second metal layer is 0.01 μm to 0.2 μm.

6. The composite metal foil of claim 1, further comprising an anti-oxidation layer covering a surface of the second metal layer.

7. The composite metal foil of claim 6, wherein the anti-oxidation layer is formed of chromic acid, benzotriazole (BTA), carboxybenzotriazole (CBTA), or methylbenzotriazole (MBTA).

8. The composite metal foil of claim 1, wherein the conductive substrate comprises a copper foil or a polymer composite copper foil.

9. The composite metal foil of claim 8, wherein the polymer composite copper foil comprises:
a polymer film; and
a copper metal layer disposed at two sides of the polymer film.

10. The composite metal foil of claim 9, wherein the polymer film comprises polyethylene terephthalate (PET), polyimide (PI), polyester (PE), polypropylene (PP), polyacrylonitrile (PAN), polymethylmethacrylate (PMMA), polydimethylsiloxane (PDMS), or a combination thereof.

11. A lithium battery, comprising a sulfur-based solid-state electrolyte, and an electrode of the lithium battery comprises the composite metal foil of claim 1.
